(19) United States
(12) Patent Application Publication
(10) Pub. No.: US 2006/0056403 A1
(43) Pub. Date: Mar. 16, 2006

(54) System and method for robust communication via a non-reliable protocol

(76) Inventors: Daniel L. Pleasant, Santa Rosa, CA (US); Gopalakrishnan Kailasam, Santa Rosa, CA (US)

Correspondence Address: AGILENT TECHNOLOGIES, INC.;INTELLECTUAL PROPERTY ADMINISTRATION, LEGAL DEPT., P.O. BOX 7599, M/S DL429, LOVELAND, CO, 80537-0599, US

(21) Appl. No.: 10/939,921

(22) Filed: Sep. 13, 2004

(51) Int. Cl. H04L 12/56; H04J 3/06

(52) U.S. Cl. 370/389; 370/503

(57) ABSTRACT

A system and method are provided which enhance the robustness of non-reliable protocols, such as UDP. As described further below, according to at least one embodiment, a method is provided for improving the robustness of using non-reliable protocols, such as UDP, in applications in which small numbers of time-critical packets are transmitted. For instance, in a system of cooperating devices on a network, a device on a network may broadcast information about itself to the other devices. According to various embodiments described below, a combination of redundant re-transmissions of non-reliable protocol data packets and inclusion of timestamps in the non-reliable protocol data packets is used to improve the robustness of applications that rely on the non-reliable protocol data packets.

### BACKGROUND OF THE INVENTION

In communication networks utilizing Internet Protocol (IP), much data is transmitted using a reliable communication protocol, such as the Transmission Control Protocol (TCP). TCP is considered a “reliable” protocol in that data packets are guaranteed to eventually reach their destination. If a packet is lost before reaching its destination, the loss of the packet is detected by the destination node (as a result of handshaking between the sender and the destination), and thus the destination node can request that the lost packet be re-transmitted. Thus, in TCP the packets are numbered and sequenced when first transmitted so that upon a retry or retransmission, the packets can be ordered correctly. TCP is normally utilized for text binary file transfer and for transferring other types of data that do not need real-time transfer. When a file is transmitted via TCP, all packets of the file are received and reassembled into the file at the destination before the destination node begins presentation of the file to a user (or to a destination application).

For high-speed applications, such as real-time applications that receive communication of audio and/or video (A/V) data (e.g., voice-over-IP, movies, music, and other types of streaming data), the data is typically transmitted over the communication network using a non-reliable protocol, such as the User Datagram Protocol (UDP). UDP is referred to as a “non-reliable” protocol because data packets (also referred to as “datagrams”) lost during transmission are not retried or re-transmitted. More particularly, a non-reliable protocol as used herein refers to a protocol in which handshaking is not performed between the sender and the destination to detect whether packets are lost. In UDP, no handshaking is performed and lost packets (that do not reach their destination) are not later re-transmitted. Accordingly, UDP is one example of a non-reliable protocol. In most streaming media applications in which UDP is utilized, if lost UDP data packets were re-transmitted at a later instant in time, the resulting data playback by the recipient may be jumbled with frames of video or audio out of order.

In general, UDP is a communication protocol that offers a limited amount of service when messages are exchanged between computers in an IP network. Like TCP, UDP uses the Internet Protocol to actually get a data packet from one computer to another. Unlike TCP, however, UDP does not provide the service of dividing a message into packets and reassembling it at the other end. Specifically, UDP does not provide sequencing of the packets that the data arrives in. UDP is typically used when a large amount of data is to be transmitted to a destination and an application at the destination desires to begin playback of the data before all of such data is received. UDP is also commonly used in which data is desired to be broadcast over a communication network.

An increasingly popular type of technology for providing information to clients is known as “streaming media.” Streaming media is one application in which a non-reliable protocol, such as UDP, is commonly used for transmitting the data packets. Streaming media is a well-known technology in the computer arts. In general, streaming media presents data (e.g., typically audio and/or video) to a client in a streaming or continuous fashion. That is, with streaming media a client is not required to receive all of the information to be presented before the presentation begins. Rather, presentation of information in a streaming media file may begin before all of the file is received by the client, and as the received portion of the file is being presented, further portions of the file continue to be received by the client for later presentation. Thus, streaming media involves media (e.g., typically audio and/or video) that is transmitted from a server ( a media server) to a client and begins playing on the client before fully downloaded.

Streaming media is a particularly popular technique for communicating audio and/or video files from a server to a client. Audio and video files tend to be quite large, even after being compressed. If streaming media is not used, an entire file is generally required to be downloaded (e.g., via TCP) to a client before the client can begin to play the file. Such a download may require an undesirably long delay before the client can begin playing the file. With streaming media (e.g., streaming audio or streaming video), a client is not required to wait until the entire file is downloaded to play it. Instead, the client can begin playing the file (e.g., presenting the video and/or audio to a user) while it downloads to the client.

Streaming media applications commonly use UDP for communicating the streams of data packets. As mentioned above, UDP does not keep re-sending packets if they are misplaced or other problems occur, as does TCP, which is preferable for most streaming media technologies. UDP is often used for broadcast transmission of data, such as transmitting programs from existing television and radio stations via an IP network.

As mentioned above, UDP is a non-reliable protocol and thus, unlike TCP, UDP packets that are transmitted over a communication network are not guaranteed to arrive at their destination. Since UDP's intended use typically is to stream large numbers of packets through the network at high speed, its non-reliability (lack of handshaking) is generally not a problem in its intended applications. The receiving unit is often able to “fill in” any information through signal processing tricks (as in voice-over-IP). Certain techniques have been proposed for improving the reliability of UDP communications by including a sequence number in each packet. Accordingly, when the destination node begins receiving the packets, it can use the sequence numbers to determine if a certain packet was not received and can request, by sequence number, re-transmission of any lost packets.

However, the above techniques do not work in situations where few packets are transmitted. For instance, if only a single UDP packet is transmitted, the intended receiver has no way of knowing when to expect the packet to arrive, or even if a packet should be expected at all. And, since UDP packet losses tend to be “bursty” because of buffer overflow issues, the same applies to small numbers of UDP packets.

Certain applications may desire to use UDP for data communication because of the high-speed capability offered by UDP, but the applications may communicate few packets. In view of the above, a desire exists for a technique for improving the robustness of communication via UDP, wherein the technique enables improved robustness even in situations in which only a few packets are communicated.

### BRIEF SUMMARY OF THE INVENTION

The present invention is directed to a system and method which enhance the robustness of applications that rely on non-reliable protocols, such as UDP. As described further below, according to at least one embodiment, a method is provided for improving the robustness of using non-reliable protocols, such as UDP, in applications in which small numbers of time-critical packets are transmitted. For instance, in a system of cooperating devices on a network, a device on a network may broadcast information about itself to the other devices. The receiving devices may, responsive to receipt of the broadcast information, take a time-critical action. Thus, the communication of UDP messages, which each may be encapsulated in a few packets, may be relied upon for coordinating/synchronizing actions of various devices. According to various embodiments described below, a combination of redundant re-transmissions of non-reliable protocol data packets and inclusion of timestamps in the non-reliable protocol data packets is used to improve the robustness of applications that rely on the non-reliable protocol data packets.

In one example embodiment, a plurality of devices are communicatively coupled to a communication network. Each of the devices has a local clock, and the local clocks are synchronized. A first of the devices communicates a UDP data packet over the communication network a plurality of times separated by at least one defined time delay, wherein a first timestamp is included in the UDP data packet each of the plurality of times the UDP data packet is transmitted. Thus, redundant re-transmission of the UDP data packet is utilized, wherein the UDP data packet is transmitted a first time and then re-transmitted at least one additional time after a given delay.

Each transmission of the UDP data packet includes a timestamp, which may, for example, correspond to the time at which the first transmission of the UDP data packet occurred, based on the local clock of the sending device. The recipient device(s) receive the UDP data packet at least once, and the recipient device(s) evaluates the timestamp to determine if it can perform a time-sensitive action responsive to the received UDP data packet.

According to at least one embodiment, a method is provided that comprises synchronizing local clocks of a plurality of devices that are communicatively coupled to a communication network. The method further comprises communicating from one of the plurality of devices at least one data packet via a non-reliable protocol over the communication network, wherein the at least one data packet includes a timestamp therein based on the local clock of the device from which the at least one packet is communicated. The method further comprises re-communicating, after a defined delay, the at least one data packet via the non-reliable protocol over the communication network, wherein the at least one data packet again includes the timestamp.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 shows an example system according to one embodiment for a robust use of a non-reliable protocol;

FIG. 2 shows an example system according to another embodiment for a robust use of a non-reliable protocol;

FIG. 3 shows an example system wherein a receiving device receives data transmitted via the non-reliable protocol in accordance with FIG. 1 or FIG. 2;

FIG. 4 shows an example operational flow for one embodiment for robust use of a non-reliable protocol; and

FIG. 5 shows an example operational flow for another embodiment for robust use of a non-reliable protocol.

### DETAILED DESCRIPTION OF THE EMBODIMENTS

As described above, certain applications may desire to use a non-reliable protocol, such as UDP, for data communication because of the high-speed and/or broadcast capability offered by the non-reliable protocol. Further, some applications may communicate few packets in a given UDP message. As an example, measurement systems often require that the operation of several instruments be synchronized (or coordinated) in an appropriate manner to allow for accurate measurements to be obtained. For instance, a spectrum analyzer should be coordinated to make its measurements after a signal source has had sufficient opportunity to settle at its output frequency. As described further in concurrently filed and commonly assigned U.S. patent application Ser. No. [Attorney Docket No. 10041329-1] titled “SYSTEM AND METHOD FOR SYNCHRONIZING OPERATIONS OF A PLURALITY OF DEVICES VIA MESSAGES OVER A COMMUNICATION NETWORK,” the disclosure of which is hereby incorporated herein by reference, messages may be communicated between various instruments of a measurement system using UDP over a communication network in order to synchronize the respective operations of the instruments. Each of the messages used for synchronization may be transmitted in only a few packets (and in some implementations in only one packet). Because the messages are time-critical in the above application of synchronizing operations of various instruments, UDP is an attractive protocol. Further, as described further in U.S. patent application Ser. No. [Attorney Docket No. 10041329-1] titled “SYSTEM AND METHOD FOR SYNCHRONIZING OPERATIONS OF A PLURALITY OF DEVICES VIA MESSAGES OVER A COMMUNICATION NETWORK,” in certain embodiments, the messages are broadcast to a plurality of instruments on the communication network, and UDP is attractive because it can be used for broadcasting messages. However, it is desirable to improve the robustness of UDP because the synchronization of various instruments is dependent upon the receipt of the UDP messages.

Methods for improving the robustness of applications that rely on non-reliable protocols, such as UDP, are provided herein. As described further below, certain embodiments disclosed herein provide improved reliability in some instances. Further, the embodiments also provide error detection to enable an intended recipient to detect when it has failed to receive a packet in sufficient time to perform time-sensitive processing that was intended to be triggered by the packet. Thus, the improved reliability and error detection provides a robust solution.

While prior techniques that have attempted to improve the reliability of UDP are directed to UDP transmissions of large numbers of packets, such as used in video or voice applications, the methods disclosed herein are effective for applications in which UDP transmissions have only a few packets. Of course, the methods provided herein may be used for improving the robustness of UDP transmissions of large numbers of packets as well. The methods described herein have particular utility for improving the robustness of UDP when used for transmitting messages for synchronizing operations of instruments, such as disclosed in U.S. patent application Ser. No. [Attorney Docket No. 10041329-1] titled “SYSTEM AND METHOD FOR SYNCHRONIZING OPERATIONS OF A PLURALITY OF DEVICES VIA MESSAGES OVER A COMMUNICATION NETWORK.” However, the methods described herein for improving the robustness of UDP may be likewise applied to any other applications in which UDP is desired for transmitting data. Further, while UDP is used in the specific example embodiments described herein, the methods provided may be readily extended to other non-reliable protocols that do not provide handshaking for detecting lost packets.

As described further below, according to at least one embodiment, a method is provided for improving the robustness of UDP in applications in which small numbers of time-critical packets are transmitted. For instance, in a system of cooperating devices on a network, a device on the network may broadcast information about itself to the other devices. This information may be time-critical. The UDP protocol is a good choice for this purpose because it can be used to efficiently broadcast information on the network (as opposed to point-to-point channels like TCP). The receiving devices need to receive the information reliably, and they need to receive it quickly. Further, in the event that all of the packets are lost, the intended recipient device(s) needs to detect this error. Since the number of transmitted packets is small, the above-described prior methods that work well for large numbers of packets will not work. Thus, a method is provided for improving the robustness of communication via UDP, which enables improved reliability and/or error detection even in situations in which only a few packets are communicated.

According to various embodiments described below, a combination of redundant re-transmissions of UDP data packets and inclusion of timestamps in the UDP data packets is used to improve the robustness of UDP. In one example embodiment, a plurality of devices are communicatively coupled to a communication network. Each of the devices has a local clock, and the local clocks are synchronized. A first of the devices communicates a UDP data packet over the communication network a plurality of times separated by at least one defined time delay, wherein a first timestamp is included in the UDP data packet each of the plurality of times the UDP data packet is transmitted. Thus, redundant re-transmission of the UDP data packet is utilized, wherein the UDP data packet is transmitted a first time and then re-transmitted at least one additional time after a given delay. As an example, the UDP data packet may be transmitted a first time, then re-transmitted a second time after a 1 millisecond (msec) delay, and then re-transmitted a third time after a 10 msec delay.

Each transmission of the UDP data packet includes a timestamp, which may correspond to the time at which the first transmission of the UDP data packet occurred, based on the local clock of the sending device. The recipient device(s) receive the UDP data packet at least once, and the recipient device(s) evaluates the timestamp to determine if it can perform a time-sensitive action responsive to the received UDP data packet. For example, suppose the UDP data packet is to trigger its recipient to make a measurement 10 msec after the timestamp included in the UDP data packet. Note that the recipient and the sender have synchronized local clocks in this example. Thus, if the first transmission of the UDP data packet is received at, say, 1 msec after the timestamp included in the message, the recipient can perform this time-sensitive measurement. If the first transmission of the UDP data packet is not received, but instead, the second transmission of the UDP data packet is received at, say, 2 msec after the timestamp included in the message, the recipient can still perform this time-sensitive measurement. Thus, the reliability is improved. Further, if neither the first nor second transmissions of the UDP data packet are received, but instead, the third transmission of the UDP data packet is received at, say, 11 msec after the timestamp included in the message, the recipient cannot trigger its measurement at 10 msec following the timestamp included in the message. However, the recipient can trigger an error in this case, as opposed to being unaware that a measurement was requested. Thus, error detection is improved for this use of a small number of packets (e.g., 1 packet).

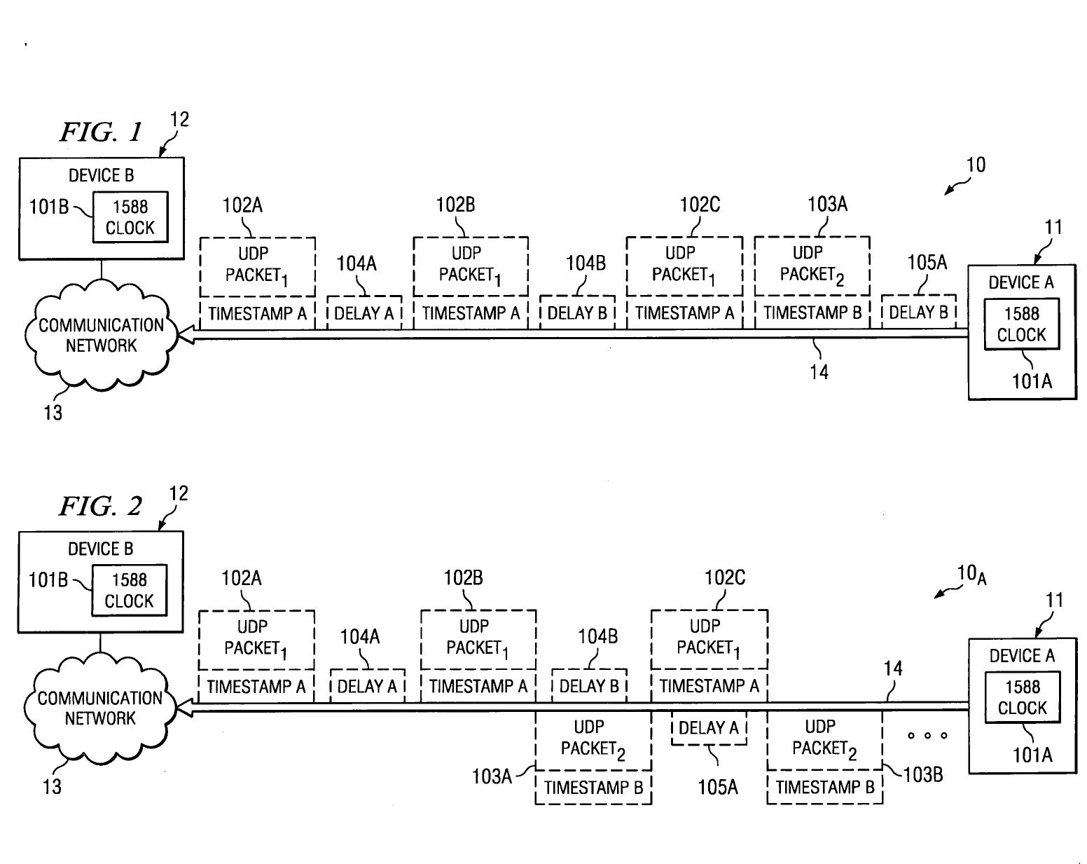

Turning to FIG. 1, an example system 10 is shown according to one embodiment for a robust use of a non-reliable protocol, which is UDP in this example. The example system 10 includes a first device 11 (device A) and a second device 12 (device B) that are communicatively coupled via a communication network 13, which may be a local area network (LAN), the Internet or other wide area network (WAN), public switched telephony network (PSTN), wireless network, any combination of the foregoing and/or any other network now known or later developed for communicating information from at least one device to at least one other device.

Each of first device 11 and second device 12 may include a central processing unit (CPU) (not shown). Further, each of first device 11 and second device 12 include local clocks that are synchronized in this example. Various techniques are known for synchronizing the clocks of networked devices to a high-degree of precision. As one example, Network Time Protocol (NTP) is a protocol that is used to synchronize computer clock times in a network of computers. In common with similar protocols, NTP uses Coordinated Universal Time (UTC) to synchronize computer clock times to within a millisecond, and sometimes to within a fraction of a millisecond. As another example, the Institute of Electrical and Electronics Engineers Standards Association (IEEE-SA) has approved a new standard for maintaining the synchrony between clocks on a network, referred to as the IEEE 1588 “Standard for a Precision Synchronization Protocol for Networked Measurement and Control Systems.” In general, this IEEE 1588 standard defines messages that can be used to exchange timing information between the networked devices for maintaining their clocks synchronized. The IEEE 1588 standard enables even a greater degree of precision (e.g., to within a microsecond) in clock synchronization than that provided by NTP. When using such techniques as NTP or IEEE 1588, the local clocks of devices are referred to as being “actively synchronized” because the devices interact with each other to maintain their respective local clocks synchronized in accordance with the particular synchronization technique employed. Other techniques (e.g., passive techniques) may be employed in alternative embodiments for synchronizing the local clocks, using GPS (global positioning system) receivers, etc.

In the specific example of FIG. 1, IEEE 1588 is used, wherein first device 11 implements IEEE 1588 clock 101A and second device 12 implements IEEE 1588 clock 101B. Of course, other techniques for actively synchronizing the local clocks, such as using Network Timing Protocol (NTP), or other techniques for passively synchronizing the local clocks (e.g., GPS) may be employed in other implementations. Thus, the first device 11 and second device 12 have their local clocks 101A and 101B synchronized to a high-degree of precision such that they have a common sense of time.

In this example, a message is communicated from first device 11 over communication network 13 using a non-reliable protocol 14, which in this example is UDP. In this example, the message is formed by a small number of UDP packets, such as two UDP packets. In certain implementations, the message may be formed by a single UDP packet. In this example transmission technique, a first UDP packet (UDP Packet₁) 102A is first transmitted, and includes a timestamp A. Timestamp A is based on the local clock 101A of first device 11, and may, for instance, be the time at which UDP packet 102A is transmitted. Thereafter, a first delay (delay A) 104A is encountered, wherein first device 11 waits for such delay time before re-transmitting the first UDP packet. UDP packet losses tend to come in bunches, so multiple packets would all be lost if sent too closely spaced in time. Accordingly, time delay A 104A is inserted between the first transmission 102A of UDP Packet₁ and the second transmission 102B of UDP Packet₁.

After delay A 104A, UDP Packet₁ is re-transmitted, shown as packet 102B, which again includes the timestamp A. It should be noted that the same timestamp (timestamp A) is included in both the first transmission 102A of UDP Packet₁ and the second transmission 102B of UDP Packet₁. Thereafter, a second delay (delay B) 104B is encountered, wherein first device 11 waits for such delay time before re-transmitting the first UDP packet a third time. Delay B 104B may be the same amount of delay as delay A 104A, or it may be defined as a different amount of delay. Further, while the UDP Packet₁ is transmitted a total of three (3) times in this example, the number of times which a UDP data packet is redundantly transmitted is not limited to this specific example. Rather, in alternative implementations the UDP Packet₁ may be transmitted two or more times with a delay between each transmission.

In the specific example of FIG. 1, after delay B 104B, UDP Packet₁ is re-transmitted, shown as packet 102C, which again includes the timestamp A. It should be noted that the same timestamp (timestamp A) is included in all of the transmissions 102A-102C of UDP Packet₁. Thereafter, the second UDP Packet (UDP Packet₂) 103A is first transmitted, and includes a timestamp B. Timestamp B is based on the local clock 101A of first device 11, and may, for instance, be the time at which UDP packet 103A is transmitted. In certain implementations, timestamp B may differ from that of timestamp A, while in other implementations timestamps A and B may be the same. For instance, timestamp B may be the time at which the first UDP packet (UDP Packet₁) was initially transmitted. Thereafter, a first delay (delay A) 105A is encountered, wherein first device 11 waits for such delay before re-transmitting the second UDP packet. Although not shown in FIG. 1, the second UDP packet may be re-transmitted one or more times, as specifically shown and described for the first UDP packet.

In certain implementations, all of the re-transmissions of the first UDP data packet need not be performed before the second UDP data packet is initially transmitted. For example, FIG. 2 shows an example system ¹⁰_{A} according to one embodiment for a robust use of a non-reliable protocol, which is UDP in this example. The example system 10_{A} again includes first device 11 and second device 12 that are communicatively coupled via communication network 13 and that implement EEEE 1588 synchronized clocks 101A and 101B, respectively.

In this example of FIG. 2, a message is communicated from first device 11 over communication network 13 using a non-reliable protocol 14, which in this example is UDP. In this example, the message is formed by two UDP packets. In the example transmission technique of FIG. 2, a first UDP packet (UDP Packet₁) 102A is first transmitted, and includes a timestamp A. Timestamp A is based on the local clock 101A of first device 11, and may, for instance, be the time at which UDP packet 102A is transmitted. Thereafter, a first delay (delay A) 104A is encountered, wherein first device 11 waits for such delay before re-transmitting the first UDP packet. As mentioned above, UDP packet losses tend to come in bunches, so multiple packets would all be lost if sent too closely spaced in time. Accordingly, time delay A 104A is inserted between the first transmission 102A of UDP Packet₁ and the second transmission 102B of UDP Packet₁.

After delay A 104A, UDP Packet₁ is re-transmitted, shown as packet 102B, which again includes the timestamp A. It should be noted that the same timestamp (timestamp A) is included in both the first transmission 102A of UDP Packet₁ and the second transmission 102B of UDP Packet₁. Thereafter, a second delay (delay B) 104B is encountered, wherein first device 11 waits for such delay time before re-transmitting the first UDP packet a third time. Delay B 104B may be the same amount of delay as delay A 104A, or it may be defined as a different amount of delay. During delay B 104B, in this example, the second UDP Packet (UDP Packet₂) 103A is first transmitted, and includes a timestamp B. Timestamp B is based on the local clock 101A of first device 11, and may, for instance, be the time at which UDP packet 103A is transmitted. In certain implementations, timestamp B may differ from that of timestamp A, while in other implementations timestamps A and B may be the same. For instance, timestamp B may be the time at which the first UDP packet (UDP Packet₁) was initially transmitted. Thereafter, a first delay (delay A) 105A is encountered, wherein first device 11 waits for such delay time before re-transmitting the second UDP packet.

During delay A 105A, UDP Packet₁ is re-transmitted, shown as packet 102C, which again includes the timestamp A. It should be noted that the same timestamp (timestamp A) is included in all of the transmissions 102A-102C of UDP Packet₁. Thereafter, the second UDP Packet (UDP Packet₂) is re-transmitted, shown as packet 103B, which again includes timestamp B (which may be the same as timestamp A in certain implementations). Although not shown in FIG. 2, the second UDP packet may be re-transmitted one or more times, as specifically shown and described for the first UDP packet.

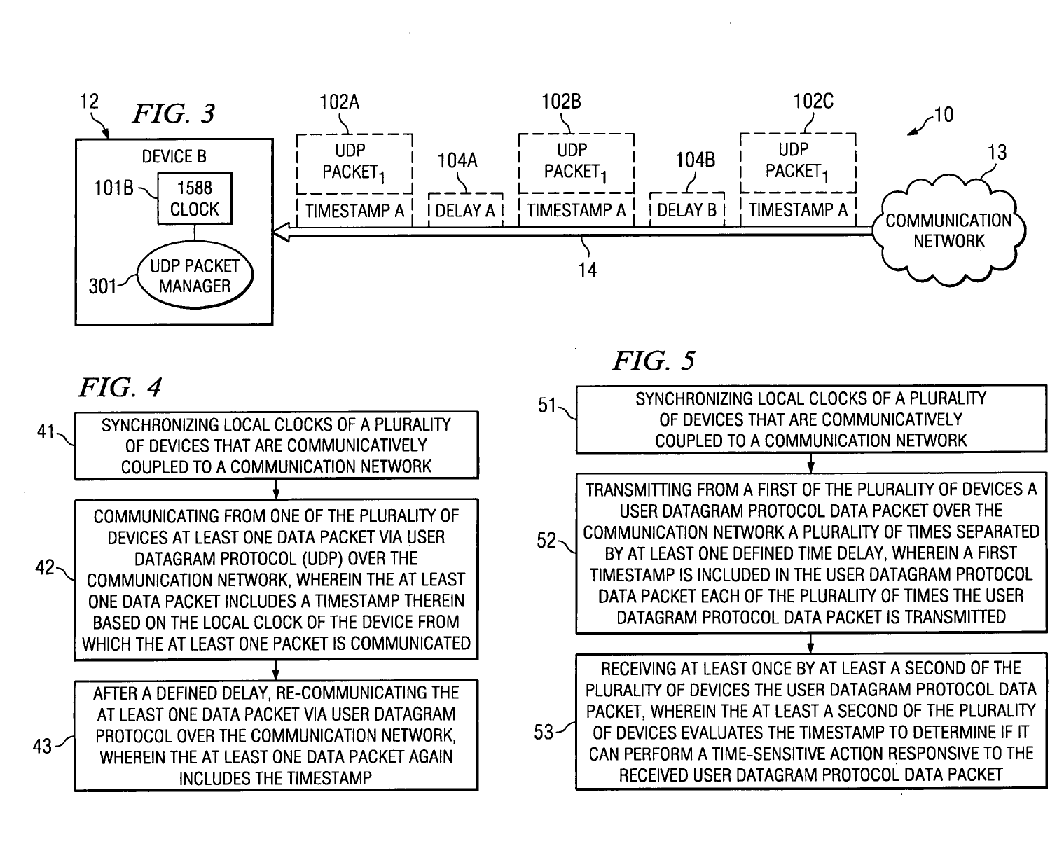

Turning now to FIG. 3, system 10 is again shown (which may be system 10 of FIG. 1 or system 10_{A} of FIG. 2), wherein second device 12 receives one or more of the redundantly transmitted first UDP packet (UDP Packet₁). Of course, if a second UDP packet is communicated, such as in the above examples of FIGS. 1 and 2, one or more of those second UDP packets will likewise be received by device 12. Device 12 includes a UDP Packet Manager 301, which upon receiving a packet compares the timestamp contained in the packet to the local time (as determined from the IEEE 1588 clock 101B). This results in a very high accuracy estimate of the amount of time that the packet took to arrive. UDP Packet Manager 301 can be pre-programmed with a “timeout” for each packet. The timeout period may vary depending on the other contents of the packet, such as an event identified by the packet. If, the measured time exceeds the timeout period, the UDP Packet Manager 301 may consider it an error and take appropriate action. Further, once one of the transmitted first UDP packets is received, UDP Packet Manager 301 is capable of ignoring receipt of later, redundant ones of such first UDP packet.

The example method of FIGS. 1-3 relies on both redundant transmission and timestamping for enhancing the robustness of applications that rely on non-reliable protocol communications. For timestamping, IEEE 1588 or a similar high-precision clock synchronization scheme is implemented on the networked devices.

Since there is no way to directly detect or recover lost UDP packets, every UDP packet is transmitted multiple times. However, retransmission does not happen immediately in the above examples because UDP packet losses tend to come in bunches, so multiple packets would all be lost if sent too closely spaced in time. Instead, a time delay is inserted between each packet transmission. The time delay that is appropriate is dependent on the application, as is the number of retransmissions that occur. For instance, UDP packets may be retransmitted after 1 msec, and again after 10 msec. More retransmissions may be necessary in cases where the amount of traffic on the communication network is high. Note that the receiving device(s) are capable of ignoring packets that arrive multiple times; but UDP packets, especially when multi-casting, can often arrive at a receiving device via several different routes, so receivers of UDP packets typically have this capability anyway.

Each packet carries a timestamp. The IEEE 1588 protocol is used in the above examples to synchronize all of the clocks in a system, and also to generate a timestamp for each UDP packet. Upon receiving a packet, the receiving device unit compares the timestamp contained in the packet to the local time (as determined from the receiver device's IEEE 1588clock). This results in a very high accuracy estimate of the amount of time that the packet took to arrive. The receiving unit can be pre-programmed with a “timeout” for each packet. (The timeout period may vary depending on the other contents of the packet.) If the measured time exceeds the timeout period, the receiver may consider it an error and take appropriate action.

Consider the following example in which a source changes its frequency and communicates a message to a receiver to trigger the receiver to make a measurement at 10 msec after the timestamp included in the message. More specifically, after changing its frequency, the source device may send a message that includes a timestamp of when its frequency was changed. The message further includes an identification of an Event #1. The receiver is programmed such that responsive to receipt of a message that identifies Event #1 to perform a measurement of the source's signal at 10 msec following the timestamp included in such message (so that the measurement is performed after the changed frequency has settled). Further, suppose that the source sends the message that identifies the Event #1 and the timestamp at which it changed its frequency in a single UDP packet.

In this example, the UDP data packet is transmitted by the source a first time, then re-transmitted a second time after a 1 millisecond (msec) delay, and then re-transmitted a third time after a 10 msec delay. Each transmission of the UDP data packet includes the timestamp at which the source changed its frequency, based on the local clock of the source. The receiver receives the UDP data packet at least once, and upon the first receipt of this UDP data packet the receiver (e.g., its UDP Packet Manager) evaluates its timestamp to determine if it can perform the time-sensitive measurement responsive to the received UDP data packet. Thus, if the first transmission of the UDP data packet is received at, say, 1 msec after the timestamp included in the message, the receiver can perform the measurement that it is to perform at 10 msec after the timestamp in the message. If the first transmission of the UDP data packet is not received, but instead, the second transmission of the UDP data packet is received at, say, 2 msec after the timestamp included in the message, the receiver can still perform this time-sensitive measurement. However, if neither the first nor second transmissions of the UDP data packet are received, but instead, the third transmission of the UDP data packet is received at, say, 11 msec after the timestamp included in the message, the receiver cannot trigger its measurement at 10 msec following the timestamp included in the message. However, the receiver can trigger an error in this case, as opposed to being unaware that a measurement was requested. Of course, if the receiver were implemented to continuously measure the signal and buffer its results in a circular buffer, the receiver may be able to retrieve the measurement corresponding to the time 10 msec following the timestamp in the message, even though the message is not received until 11 msec after the timestamp in the message. In this case, the receiver may generate an error if the measurement for the desired time (e.g., 10 msec following the timestamp) is no longer in the receiver's buffer.

Turning to FIG. 4, an example operational flow for one embodiment is shown. In operational block 41, local clocks of a plurality of devices that are communicatively coupled to a communication network are synchronized. An active synchronization technique, such as IEEE 1588 or NTP, can be used for synchronizing the local clocks in certain embodiments, as described above. In block 42, at least one UDP data packet is communicated from one of the plurality of devices over the communication network. The UDP data packet(s) is broadcast over the communication network in certain embodiments. The UDP data packet(s) includes a timestamp therein based on the local clock of the sending device. Then, in block 43, after a defined delay, the UDP data packet is re-communicated over the communication network and again includes the timestamp.

Turning to FIG. 5, another example operational flow for one embodiment is shown. In operational block 51, local clocks of a plurality of devices that are communicatively coupled to a communication network are synchronized. Again, an active synchronization technique, such as IEEE 1588 or NTP, can be used in certain embodiments for synchronizing the local clocks. In operational block 52, a UDP data packet is transmitted from a first of the plurality of devices over the communication network a plurality of times separated by at least one defined time delay. In certain embodiments, the UDP data packet is broadcast over the communication network. A first timestamp is included in the UDP data packet each of the plurality of times the UDP data packet is transmitted. For instance, such timestamp may correspond to the time on the local clock of the first device when the UDP data packet is initially transmitted. In operational block 53, at least a second one of the plurality of devices receives the UDP data packet at least once. The receiving device evaluates the timestamp to determine if it can perform a time-sensitive action responsive to the received UDP data packet. As mentioned above, if determined that the received UDP data packet is too late to enable the receiver to perform a time-sensitive action, the receiver may take appropriate action, such as generate an error.

While the above examples are described above for the UDP protocol, it should be understood that the techniques may be readily extended for use with other non-reliable protocols to enhance the robustness of using those protocols. Further, while the methods described herein have particular utility for improving the robustness of non-reliable protocols when used for transmitting messages for synchronizing operations of instruments, such as disclosed in U.S. Patent application Ser. No. [Attorney Docket No. 10041329-1] titled “SYSTEM AND METHOD FOR SYNCHRONIZING OPERATIONS OF A PLURALITY OF DEVICES VIA MESSAGES OVER A COMMUNICATION NETWORK,” the methods described herein may be likewise applied to any other applications in which a non-reliable protocol is desired for transmitting data, particularly applications in which only a few data packets are transmitted.

Although the present invention and its advantages have been described in detail, it should be understood that various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A method comprising:
synchronizing local clocks of a plurality of devices that are communicatively coupled to a communication network;
communicating from one of the plurality of devices at least one data packet via a non-reliable protocol over the communication network, wherein the at least one data packet includes a timestamp therein based on the local clock of the device from which the at least one packet is communicated; and
after a defined delay, re-communicating the at least one data packet via the non-reliable over the communication network, wherein the at least one data packet again includes the timestamp.

2. The method of claim 1 wherein the non-reliable protocol is user datagram protocol (UDP).

3. The method of claim 1 wherein said communicating comprises broadcasting said at least one data packet over the communication network.

4. The method of claim 1 further comprising:
after another defined delay, re-communicating the at least one data packet via the non-reliable protocol over the communication network, wherein the at least one data packet again includes the timestamp.

5. The method of claim 1 wherein said synchronizing uses one selected from the group consisting of: IEEE 1588, Network Time Protocol (NTP), and global positioning system (GPS).

6. The method of claim 1 wherein said synchronizing comprises:
said plurality of devices interacting to actively synchronize their local clocks.

7. The method of claim 1 further comprising:
at least one of said plurality of devices receiving said at least one data packet at least once from said communicating and said re-communicating.

8. The method of claim 7 further comprising:
said at least one of said plurality of devices receiving said at least one data packet and determining if it can perform a time-sensitive operation relative to the timestamp included in the at least one data packet.

9. A method comprising:
synchronizing local clocks of a plurality of devices that are communicatively coupled to a communication network;
forming a first data packet of a non-reliable protocol, said first data packet including a first timestamp therein based on the local clock of a first one of the plurality of devices;
communicating from the first one of the plurality of devices the first data packet over the communication network via the non-reliable protocol; and
re-communicating, via the non-reliable protocol, the first data packet over the communication network at least once after at least one defined time delay.

10. The method of claim 9 wherein the first data packet is a user datagram protocol (UDP) data packet.

11. The method of claim 9 wherein said communicating comprises broadcasting said first data packet over the communication network.

12. The method of claim 9 wherein said re-communicating comprises:
re-communicating the first data packet a plurality of times, each of said plurality of times separated by a time delay.

13. The method of claim 9 wherein the first data packet includes the first timestamp when re-communicated in said re-communicating step.

14. The method of claim 9 wherein said synchronizing uses one selected from the group consisting of: IEEE 1588, Network Time Protocol (NTP), and global positioning system (GPS).

15. The method of claim 9 further comprising:
at least one of said plurality of devices receiving said first data packet at least once as a result of said communicating and said re-communicating.

16. The method of claim 15 further comprising:
said at least one of said plurality of devices receiving said first data packet and determining if it can perform a time-sensitive operation relative to the timestamp included in the at least one data packet.

17. The method of claim 16 wherein said first data packet further includes information identifying an event, and wherein said determining if it can perform a time-sensitive operation comprises determining a time-sensitive operation to perform responsive to said identified event.

18. A method comprising:
synchronizing local clocks of a plurality of devices that are communicatively coupled to a communication network;
transmitting from a first of the plurality of devices a user datagram protocol (UDP) data packet over the communication network a plurality of times separated by at least one defined time delay, wherein a first timestamp is included in the UDP data packet each of the plurality of times the UDP data packet is transmitted; and
receiving at least once by at least a second of the plurality of devices the UDP data packet, wherein the at least a second of the plurality of devices evaluates the timestamp to determine if it can perform a time-sensitive action responsive to the received UDP data packet.

19. The method of claim 18 wherein said transmitting comprises broadcasting said UDP data packet over the communication network.

20. The method of claim 18 wherein said synchronizing uses one selected from the group consisting of: IEEE 1588, Network Time Protocol (NTP), and global positioning system (GPS).

21. A system comprising:
a plurality of devices that are communicatively coupled to a communication network;
each of the plurality of devices include a local clock, wherein the local clocks are actively synchronized;
at least a first one of the plurality of devices generates a message to be communicated over the communication network to at least a second one of the plurality of devices, wherein the at least a second one of the plurality of devices includes an application that is operable to receive the message and responsive to the message perform a time-sensitive action;
wherein the at least a first one of the plurality of devices forms the generated message into at least one non-reliable protocol data packet that includes a timestamp based on the local clock of the at least a first one of the plurality of devices, and wherein the at least a first one of the plurality of devices communicates the at least one non-reliable protocol data packet a plurality of times separated by at least one defined time delay.

22. The system of claim 21 wherein the at least one non-reliable protocol data packet is a user datagram protocol (UDP) data packet.

23. The system of claim 21 wherein the time-sensitive action comprises taking a measurement.

24. The system of claim 23 wherein said taking a measurement comprises taking a measurement of a signal output by said at least a first one of the plurality of devices.

25. The system of claim 21 wherein said message identifies an event, and wherein said at least a second one of the plurality of devices is configured to determine said time-sensitive action that it is to perform responsive to the identified event.
